(19) United States
(12) Patent Application Publication
(10) Pub. No.: US 2016/0177461 A1
(43) Pub. Date: Jun. 23, 2016

(54) ALUMINIUM ELECTROLYTIC POT RAMMING MACHINE

(71) Applicant: STAS INC., Saguenay (CA)

(72) Inventors: Giovanni PUCELLA, Saguenay (CA); Pascal CÔTÉ, Chicoutimi (CA)

(73) Assignee: STAS INC., Saguenay, QC (CA)

(21) Appl. No.: 14/907,752

(22) PCT Filed: Jul. 25, 2014
(86) PCT No.: PCT/CA2014/000590

§ 371 Date: Jan. 26, 2016

Related U.S. Application Data
(60) Provisional application No. 61/858,972, filed on Jul. 26, 2013.

(51) Int. Cl. C25C 3/08; F27D 1/16

(52) U.S. Cl. CPC C25C 3/085; F27D 1/16

(57) ABSTRACT

The present document describes a machine for compacting a ramming paste inside a gap between cathodes of an electrolytic cell. The machine comprises a guiding rod for providing a static pressure in a longitudinal axis which is coincident with the guiding rod; a vibration generator attached to the guiding rod for providing an oscillatory pressure; and a compaction tool attached to one of the guiding rod and the vibration generator for transmitting the static pressure and the oscillatory pressure to the ramming paste inside the gap.

### CROSS-REFERENCE TO RELATED APPLICATIONS

This application claims priority from U.S. provisional patent application No. 61/858,972 filed on Jul. 26, 2013.

### BACKGROUND

(a) Field

The subject matter disclosed generally relates to aluminium production. More particularly, the subject matter disclosed relates to machinery used for lining electrolytic cells in the aluminium production industry.

(b) Related Prior Art

The aluminium electrolysis process is crucial in the aluminium production industry. It relies on the use of electrolytic cells or pots in which the reduction of alumina occurs. An essential step called pot lining is critical during the construction of the cell. In order to expand the lifespan of the pot, the pot has to be properly lined. The pot lining usually consists of installing different layers of materials, typically bricks, alumina and carbon blocks which isolate the pot shell, which is made of steel, from the harsh conditions, control the heat balance of the pot and contain the molten aluminium and electrolytic bath.

Cathode blocks are installed side to side on these bricks, and a gap exists between the cathode blocks. The cathode blocks, in combination with anodes suspended in the electrolyte, allow the electrical current to flow, which is at the heart of the electrolysis process. Cathode blocks are usually made of graphite or other form of carbon.

The cathode needs to be resistant to leaking, because a leakage of molten aluminium or electrolyte bath under the cathode blocks would reduce considerably the lifespan of the pot. Resistance to leaking is obtained by adding a paste called ramming paste to fill the gap between the cathode blocks. The ramming paste is usually made of a carbonaceous substance, most often anthracite.

Once the ramming paste is injected in the gap between the cathode blocks, it has to be compacted in order to be fully resistant to leaking. A compaction tool known as a pot ramming machine (or pot lining machine) is used for that purpose, using vibrations or mechanical forces to apply a repeated pressure on the surface of the joint between cathode blocks to compact the ramming paste inside the gap.

The prior art discloses a compaction tool in which the repeated pressure is applied by an arm which follows an arc of circle shaped motion, which is not optimal with regard to the purpose of the movement.

There is thus a need for a compaction tool that works using a linear motion to produce the repeated pressure on the surface of the joins, therefore applying a force perpendicular to a surface through the entire stroke to achieve a homogeneously compacted joins at every cross section area throughout the entire pot.

Generally speaking, the vibration generator is tied to an upper structure (usually a gantry) which allows the compaction tool to translate over all the cathode blocks. However, the vibration generator found in the prior art transmits the vibration to this upper structure, thus reducing the lifespan of the whole system and generating maintenance costs. There is also significant noise generation by operating the prior art vibration generators. Among others, the use of a rubber cushion does not allow a sufficient mechanical decoupling between the compaction tool and the upper structure.

There is thus a need for a compaction module which is designed to reduce the vulnerability of the upper structure to vibration by decoupling the vibrating compaction tool from the upper structure.

### SUMMARY

According to an embodiment, there is provided a machine for compacting a ramming paste inside a gap between cathodes of an electrolytic cell. The machine comprises a guiding rod for providing a static pressure in a longitudinal axis which is coincident with the guiding rod; a vibration generator attached to the guiding rod for providing an oscillatory pressure; and a compaction tool attached to one of the guiding rod and the vibration generator for transmitting the static pressure and the oscillatory pressure to the ramming paste inside the gap.

According to an aspect, the machine further comprises a gantry, wherein the guiding rod is adapted to be attached under the gantry for support.

According to an aspect, the guiding rod further comprises a vibration isolation device for decoupling vibrations between the vibration generator and the gantry.

According to an aspect, the machine further comprises a translation frame between the guiding rod and the gantry to enable translation of the guiding rod with respect to the gantry.

According to an aspect, the vibration generator attached to the guiding rod is located under the guiding rod.

According to an aspect, the vibration generator attached to the guiding rod is located above the guiding rod.

According to an aspect, the vibration generator comprises eccentric weights which are enabled for rotating for providing the oscillatory pressure and which are adjustable manually for varying the oscillatory pressure.

According to an aspect, the vibration generator comprises vibration isolators for allowing an amplitude of motion and for absorbing vibrations.

According to an aspect, the machine is enabled for pulling up the guiding rod higher than walls of the electrolytic cell for enabling horizontal translation of the guiding rod over another electrolytic cell without lifting the machine in its entirety.

According to another embodiment, there is provided a guiding rod for compacting a ramming paste inside a gap between cathodes of an electrolytic cell, the cathodes defining a surface. The guiding rod has a weight and comprises a ram, which is coincident with a pushing axis and which can transmit a force along the pushing axis; a barrel surrounding the ram for confining a pressurized fluid in either an upper pressure chamber or a lower pressure chamber within the barrel; a piston for separating the upper pressure chamber and the lower pressure chamber and for providing the force to the ram when the upper pressure chamber and the lower pressure chamber are at different pressures.

According to an aspect, the pushing axis is vertical regardless of how the surface of the cathodes is inclined.

According to an aspect, the pushing axis is normal to the surface of the cathodes.

According to an aspect, the guiding rod further comprises at least one of bushings and bearings around the ram for providing rotatability of the ram around the pushing axis.

According to another embodiment, there is provided a method for compacting a ramming paste inside a gap between cathodes of an electrolytic cell. The method comprises providing, using a guiding rod, a static pressure in a longitudinal axis which is coincident with the guiding rod; providing an oscillatory pressure at a vibration generator; and transmitting, with a compaction tool, the static pressure and the oscillatory pressure to the ramming paste inside the gap.

According to an aspect, using a guiding rod comprises using a guiding rod having a weight, wherein providing a static pressure comprises applying the weight of the guiding rod.

According to an aspect, using a guiding rod comprises using a guiding rod comprising piston, wherein providing a static pressure comprises applying a force with the piston.

According to an aspect, using a guiding rod further comprises using a guiding rod having a weight, wherein providing a static pressure comprises applying the weight of the guiding rod.

According to an aspect, providing an oscillatory pressure comprises rotating eccentric weights for generating a vibration and further comprising manually adjusting a position of the eccentric weights to thereby vary the oscillatory pressure.

According to an aspect, the method further comprises horizontally translating the guiding rod over the cathodes of the electrolytic cell for compacting a ramming paste inside another gap.

According to an aspect, the method further comprises pulling up the guiding rod higher than walls of the electrolytic cell for enabling horizontal translation of the guiding rod over another electrolytic cell without lifting all mechanical components used in the method.

### BRIEF DESCRIPTION OF THE DRAWINGS

Further features and advantages of the present disclosure will become apparent from the following detailed description, taken in combination with the appended drawings, in which:

FIG. 1 is a side view illustrating a pot ramming machine found in the prior art;

FIGS. 2A to 2C are perspective views illustrating a pot ramming machine in various contexts according to an embodiment; and

FIGS. 3A to 3E are cross sections illustrating the pot ramming machine of FIGS. 2A to 2C in various contexts.

It will be noted that throughout the appended drawings, like features are identified by like reference numerals.

### DETAILED DESCRIPTION

In embodiments described herein there is disclosed a ramming machine for lining an electrolysis cell, for example an electrolytic cell used in the aluminium production industry.

### Definitions

An electrolytic cell, also known as a pot, is a container used in the aluminium production. Among others, the electrolytic cell or pot comprises a pot shell as an envelope, electrodes, a heated electrolytic bath for containing alumina, and molten aluminium produced by the electrolysis. The electrodes comprise an anode suspended in the electrolytic bath and a cathode in the bottom of the shell.

The cathode is made of carbon that lies in the bottom of the cell. For practical reasons, the cathode usually comprises a plurality of blocks called cathode blocks.

Having a plurality of cathode blocks creates a gap between each cathode block. The gap width may range between 40 mm and 300 mm, for example. If not properly compacted, the molten aluminium or the electrolytic bath will leak and reach the steel shell, thus deeply damaging this part of the cell, which will stop working. This is why the gap has to be filled with a paste called ramming paste or seam mix.

The ramming paste is a carbonaceous paste which has a basis of anthracite and uses pitch as a binder. The composition ensures that the paste can achieve its function, but the step of compacting the gap filled by such a substance is quite exhausting for the user/operator and does not give consistent results if performed manually, thus requiring a pot ramming machine (if done manually, a pneumatic compaction tool would be used).

The compaction tool is a solid surface or volume that is used to press on the ramming paste to compact it.

The process of compacting the ramming paste in the gaps between the cathode blocks is named in various ways, such as: electrolytic cell lining, pot lining, electrolytic cell ramming or pot ramming. The machine used for such performing this task is named in various ways, such as: cell lining machine, pot lining machine, electrolytic cell ramming machine or pot ramming machine.

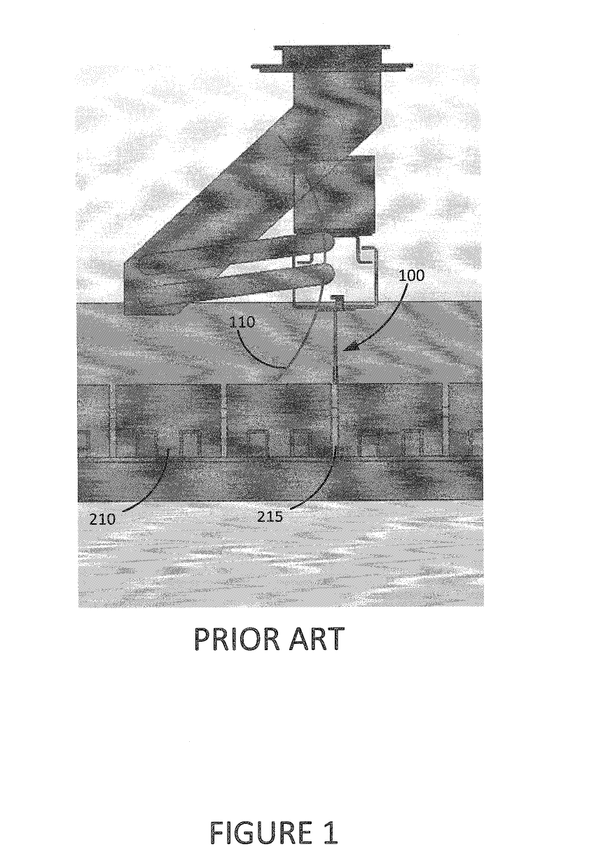

Referring now to the drawings, and more particularly to FIG. 1, a side view illustrates a pot ramming machine found in the prior art. The bottom of the cell under construction is showed with the plurality of cathode blocks 210, which are separated by gaps 215. The prior art compaction tool 100 is shown compacting the ramming paste (not shown) in the gaps 215. The arc of circle shaped motion 110 of the prior art compaction tool 100 is suggested.

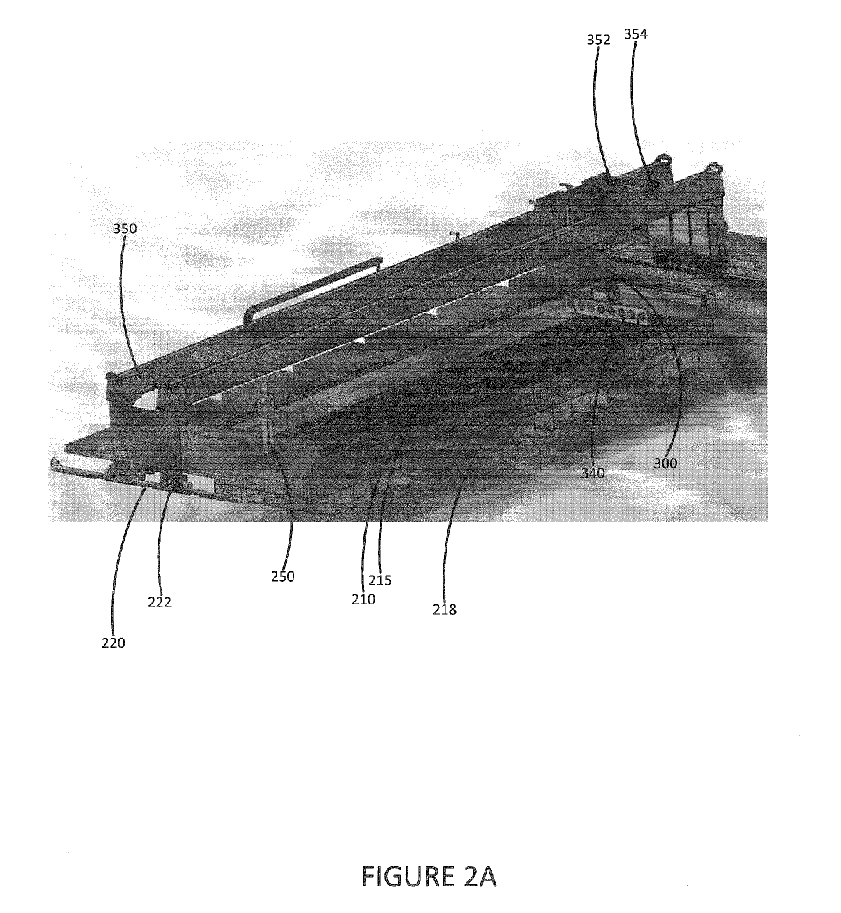

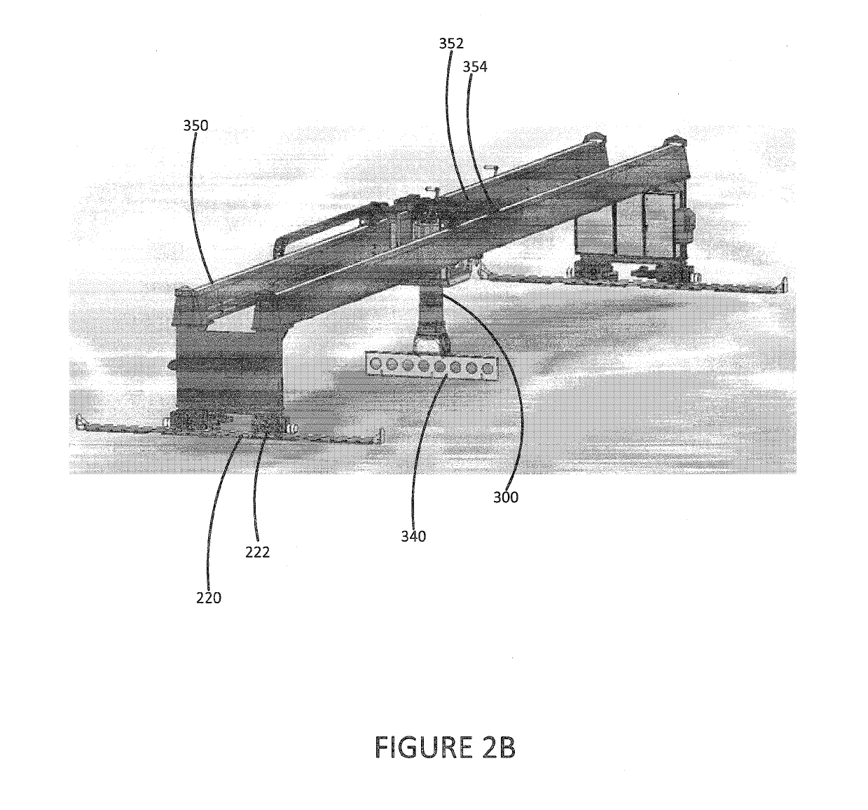

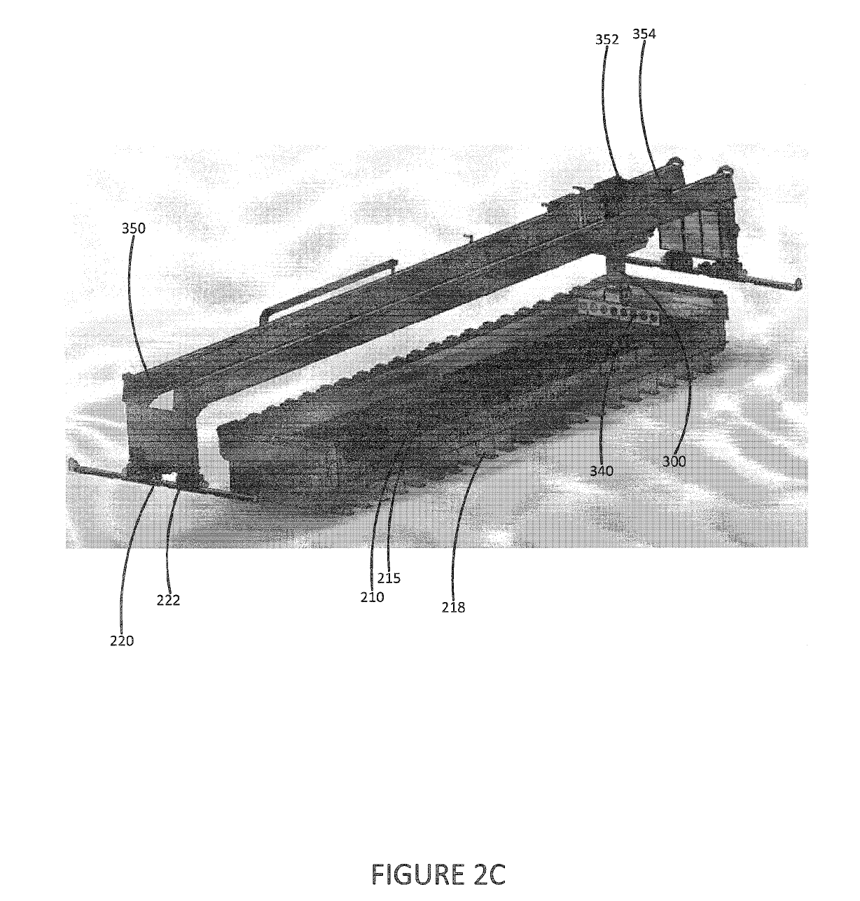

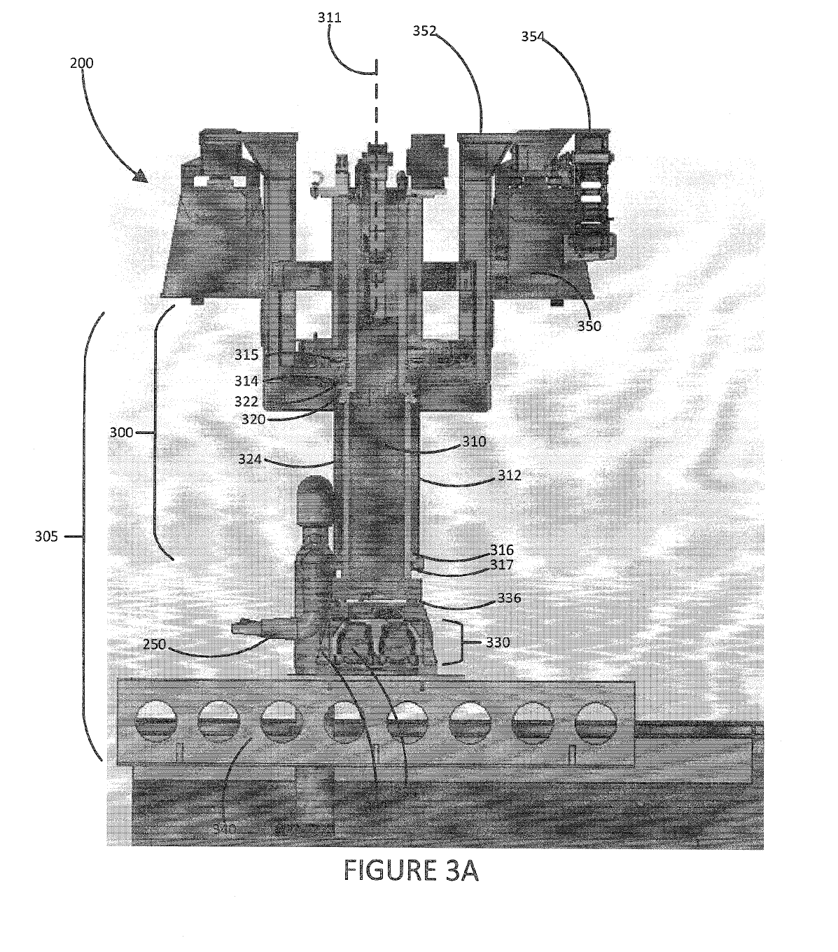

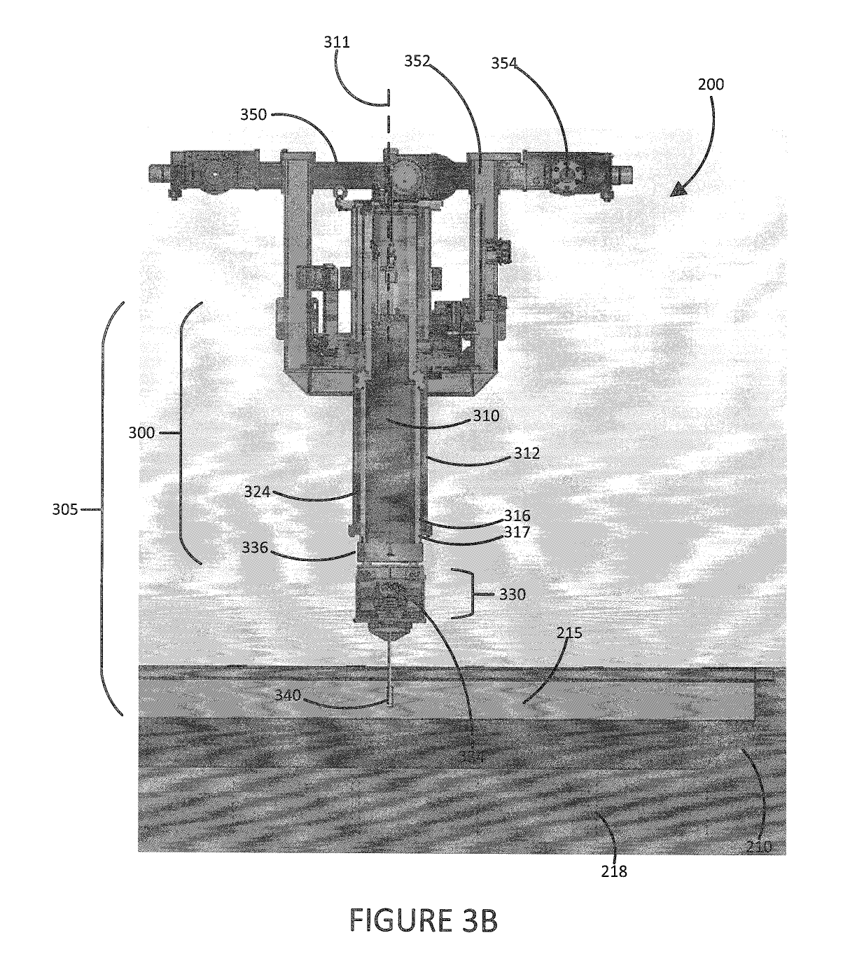

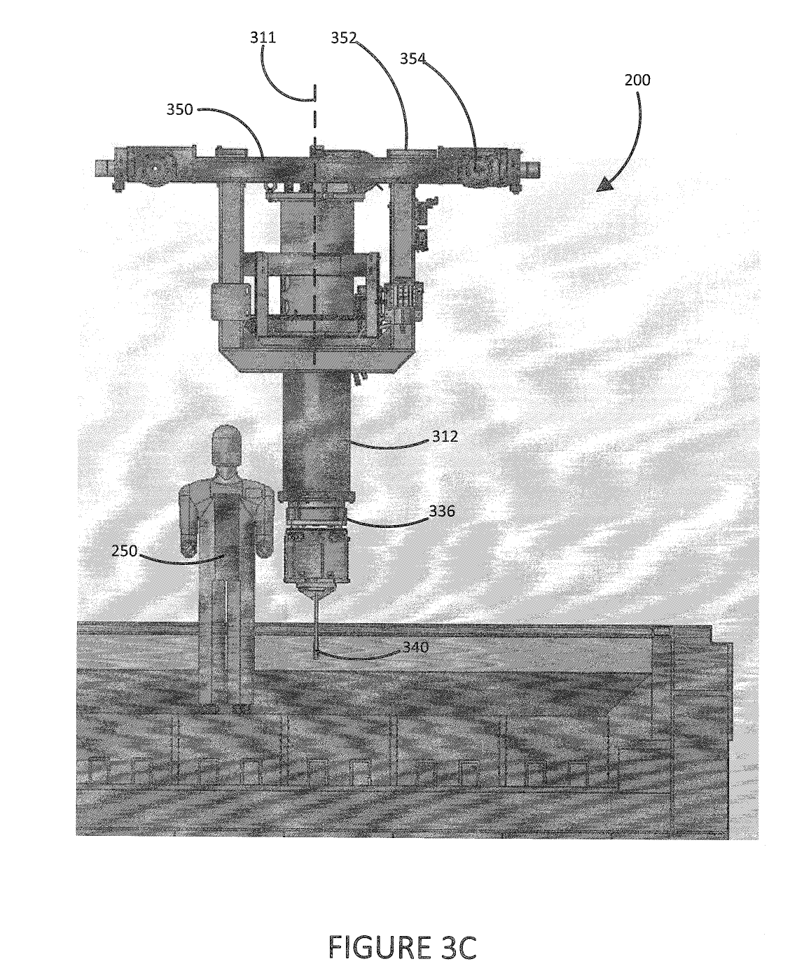

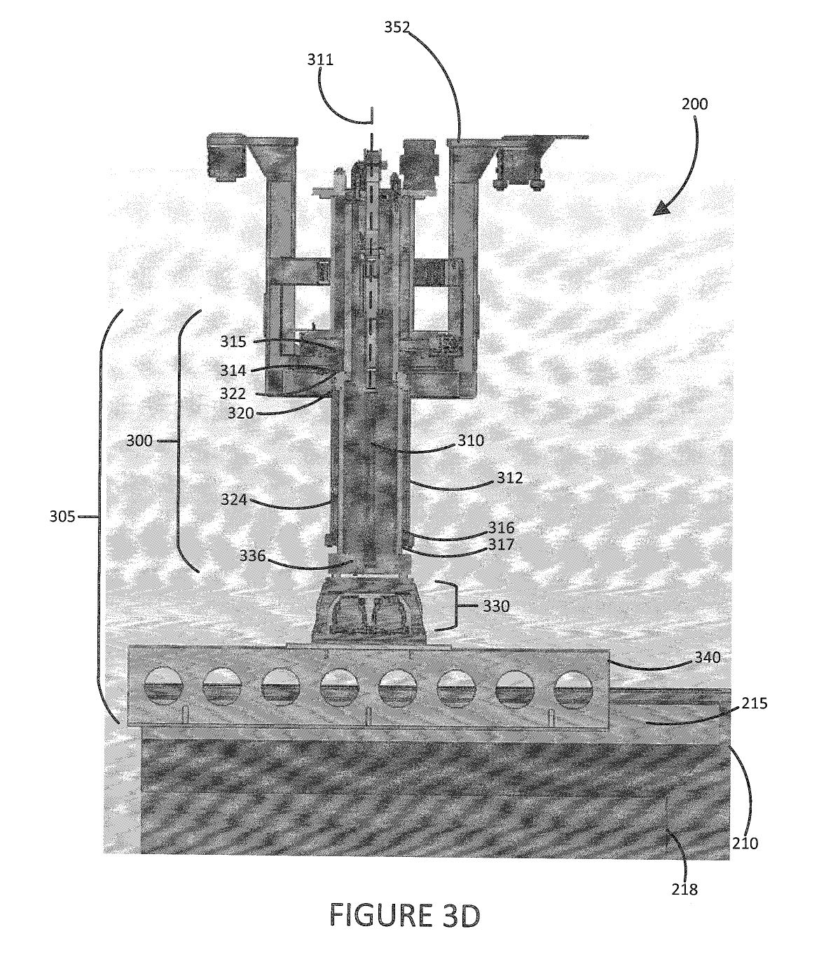

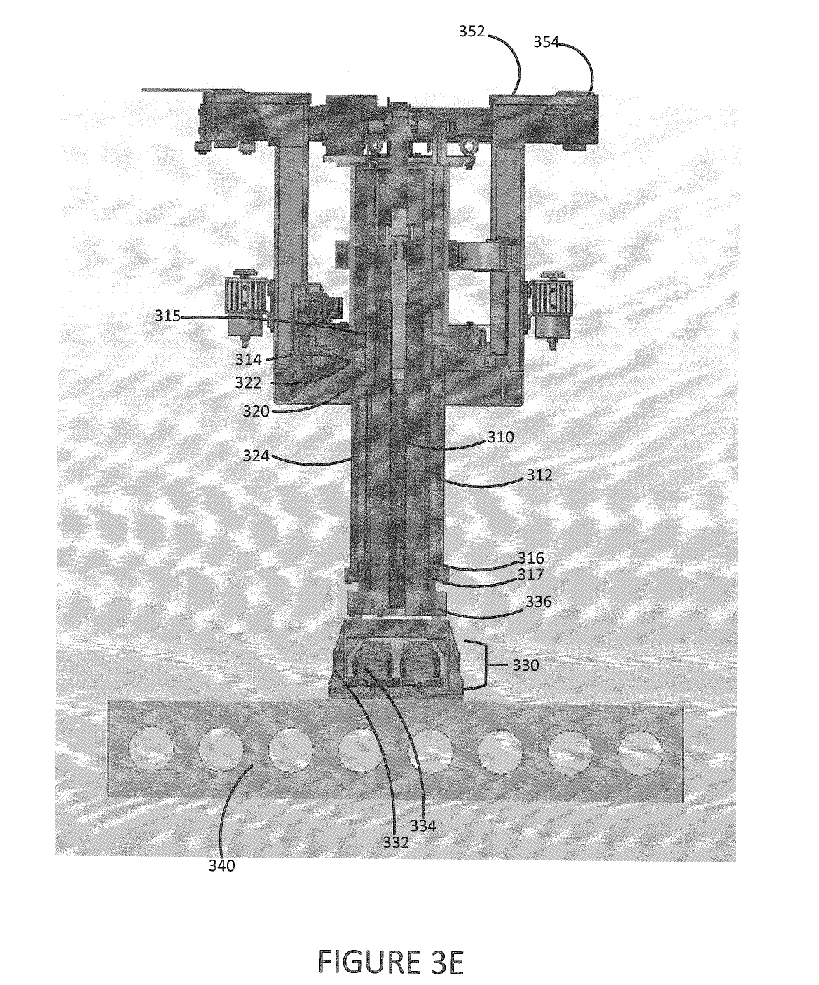

FIGS. 2A to 2C are perspective views illustrating the pot ramming machine 200 in use (with the electrolytic cell and with the floor in FIG. 2A, without the cell and without the floor in FIG. 2B, and with the electrolytic cell but without the floor in FIG. 2C). In an electrolytic cell bottom 218, the cathode blocks 210 can be seen, separated by the gaps 215. The compaction tool 340 lies above the gaps 215, ready for compaction. The compaction tool 340 is maintained by a guiding rod 300 (shown in a simplified view), which is described more thoroughly hereinbelow in relation with FIGS. 3A to 3E. The guiding rod 300 and compaction tool 340 assembly is suspended over the plurality of cathode blocks 210 using a gantry 350. The gantry 350 may be replaced by any type of frame or a structure that is known by a person skilled in the art to be able to hold the compaction module 305 in place. The guiding rod 300 and compaction tool 340 assembly is attached to the gantry 350 with a translation frame 352 holding the guiding rod 300, with the sides of the translation frame 352 lying on the gantry 350. Rail wheels 354, attached to the translation frame 352, allow the translation frame 352 to translate on the gantry 350 in the direction of the beams (or rails) that make up the gantry 350. The gantry 350 can also translate in another direction on a static rail 220, using gantry rail wheels 222. A user 250 may supervise the operation or operate the pot ramming machine 200.

With regard to FIGS. 3A to 3E, there are illustrated cross sections of the pot ramming machine 200 in various orientations or with/without a user 250 or electrolytic cell. The translation frame 352 is shown holding the guiding rod 300 and lying on the gantry 350, with the use of rail wheels 354 to allow translation of the translation frame 352 on the gantry 350. The rail wheels 354 could be replaced by any other translation enabling device. A user 250 may operate the pot ramming machine 200. At the heart of the pot ramming machine 200 is a compaction module 305, which provides the necessary forces to compress the ramming paste. The compaction module 305 comprises everything from the guiding rod 300 down to the compaction tool 340.

The guiding rod 300 is shown in more detail in FIGS. 3A to 3E. In the embodiment illustrated in FIG. 3, the guiding rod 300 is represented as a double rod pneumatic cylinder. In this embodiment, the guiding rod 300 comprises a cylinder barrel 312 forming its outside portion. The cylinder barrel 312 is held by the translation frame 352. The cylinder barrel 312 comprises an upper pressure chamber 322 and a lower pressure chamber 324, these two chambers being separated by a piston 320. A pressurized fluid is confined in either the upper pressure chamber 322 or the lower pressure chamber 324 within the cylinder barrel 312. In the longitudinal axis 311 of the cylinder barrel 312 is found a ram 310, also known as a rod. The ram 310 is a double rod in the illustrated embodiment, but may be any other type of ram known by a person skilled in the art to work in this situation. The ram 310 is coincident with the longitudinal axis 311 (aka a pushing axis). The ram 310 may be over-dimensioned to reduce the strain in the materials caused by the side loading if it occurs. At the top of the upper pressure chamber 322, between the ram 310 and the cylinder barrel 312, an upper seal 314 seals the upper pressure chamber 322 and an upper bearing 315 allow rotation around the longitudinal axis 311 of the ram 310. At the bottom of the lower pressure chamber 324, between the ram 310 and the cylinder barrel 312, a lower seal 316 seals the lower pressure chamber 324 and a lower bearing 317 allows rotation.

FIGS. 3A to 3E also illustrates how the ram 310 and the cylinder barrel 312 are attached to a cylinder base 336. The cylinder base 336 is also attached from its bottom to the compaction tool 340 vibration generator 330, located between the cylinder base 336 and the compaction tool 340. The vibration generator 330 generates pressure oscillations (which are periodic or intermittent) or any other type of vibration. The vibration generator 330 comprises rotatable eccentric weights 334. The rotatable eccentric weights 334, when in rotation, cause unbalance in their own rotational movement and generate a mechanical oscillation of a frequency between 30 and 80 Hz, and an amplitude up to 5 mm in the direction of a longitudinal axis 311. The rotatable eccentric weights 334 are adjustable manually as to their relative position for varying (increasing or decreasing) the oscillatory pressure. The vibration generator 330 further comprises vibration isolators 332 (aka a vibration isolation device) to absorb vibrations and allow amplitude of motion.

The compaction may have to be done over an inclined surface (e.g. when compacting the peripheral gap between the cathode blocks and the shell). The compaction tool 340 is thus interchangeable to allow the use of an inclined compaction tool (not shown), or a compaction tool 340 adapted for the dimensions of the gaps 215 that are being rammed. The dimensioning of the guiding rod 300 is made to allow compaction when the compaction tool 340 is inclined; it is why the ram 310 is oversized for compacting on a flat surface, as mentioned hereinabove.

The guiding rod 300 embodied as a pneumatic cylinder, in this example, is able to transmit a static pressure to the compaction tool 340, or a pressure varying substantially linearly with time, whereas the vibration generator 330 adds an oscillatory movement and pressure. Both these components of the pressure function help the ramming paste to be compacted properly in the gaps 215. The static pressure is provided in a longitudinal axis 311 which is coincident with the guiding rod 300 (i.e., the longitudinal axis of the guiding rod 300 and the longitudinal axis in which the static pressure is provided are coincident).

In order to prevent the vibration to be transmitted to the gantry 350, it is preferable to decrease the pressure in the upper pressure chamber 322 and in the lower pressure chamber 324.

For instance, according to an embodiment, the upper pressure chamber 322 and in the lower pressure chamber 324 are both deleted from the design. In this case, there is no need for the piston 320, and what would stay in the design is a vertically positioned ram acting as the guiding rod 300, just like the ram 310. The ram 310 that is used may have a weight that is sufficient to compact the ramming paste, therefore, there is no need for a pneumatically powered ram in such an embodiment.

According to other embodiments, the guiding rod 300 is a hydraulic cylinder or a single rod cylinder.

More generally, any type of ram known by a person skilled in the art could work. Preferably, the ram 310 would be a vertically positioned ram, although it is possible to use an inclined ram (not shown) to apply pressure on an inclined surface. In all cases, the movement of the ram 310 is linear and follows the longitudinal axis 311 collinear with the ram 310. The section of the ram 310 may also have any shape, although a circular shape is preferred if bushings or bearings are to be used to provide rotation.

The movement of the ram 310 is one-dimensional in the longitudinal axis 311. It may also rotate around the longitudinal axis 311. It may therefore achieve its function in a more efficient and simple way than what is found in the prior art (for example what is shown in FIG. 1).

According to an embodiment, the guiding rod 300 may have enough stroke to allow the pot ramming machine 200 to be entirely pulled above the electrolytic cell walls and thus be transferred on another electrolytic cell under construction with no more equipment than what is described in FIG. 3, a feature not found in the known prior art, with the electrolytic cell located under the floor level (the top of the cell under construction is usually flush with the floor level).

Moreover, it should be noted that the design of the pot ramming machine 200 illustrated in FIG. 3 has the advantage of reducing the noise and the vibrations transmitted to the gantry 350 by comparison with the prior art. Since the guiding rod 300 lies between the vibration generator 330 and the gantry 350, its mass is able to absorb the vibration that would be transmitted to the gantry 350, and since it is free to move vertically (not mechanically connected), the force transmissibility is almost non-existent. Thus the guiding rod 300 helps in reducing the maintenance needs when compared with those of the guiding rods in the prior art. The vibration isolators 332 also contribute to the vibration attenuation.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A machine for compacting a ramming paste inside a gap between cathodes of an electrolytic cell, the machine comprising:
a guiding rod for providing a static pressure in a longitudinal axis which is coincident with the guiding rod;
a vibration generator attached to the guiding rod for providing an oscillatory pressure; and
a compaction tool attached to one of the guiding rod and the vibration generator for transmitting the static pressure and the oscillatory pressure to the ramming paste inside the gap.

2. The machine of claim 1, further comprising a gantry, wherein the guiding rod is adapted to be attached under the gantry for support.

3. The machine of claim 2, wherein the guiding rod further comprises a vibration isolation device for decoupling vibrations between the vibration generator and the gantry.

4. The machine of claim 2, further comprising a translation frame between the guiding rod and the gantry to enable translation of the guiding rod with respect to the gantry.

5. The machine of claim 1, wherein the vibration generator attached to the guiding rod is located under the guiding rod.

6. The machine of claim 1, wherein the vibration generator attached to the guiding rod is located above the guiding rod.

7. The machine of claim 1, wherein the vibration generator comprises eccentric weights which are enabled for rotating for providing the oscillatory pressure and which are adjustable manually for varying the oscillatory pressure.

8. The machine of claim 1, wherein the vibration generator comprises vibration isolators for allowing an amplitude of motion and for absorbing vibrations.

9. The machine of claim 1, wherein the machine is enabled for pulling up the guiding rod higher than walls of the electrolytic cell for enabling horizontal translation of the guiding rod over another electrolytic cell without lifting the machine in its entirety.

10. A guiding rod for compacting a ramming paste inside a gap between cathodes of an electrolytic cell, the cathodes defining a surface, the guiding rod having a weight and comprising:
a ram, which is coincident with a pushing axis and which can transmit a force along the pushing axis;
a barrel surrounding the ram for confining a pressurized fluid in either an upper pressure chamber or a lower pressure chamber within the barrel;
a piston for separating the upper pressure chamber and the lower pressure chamber and for providing the force to the ram when the upper pressure chamber and the lower pressure chamber are at different pressures.

11. The guiding rod of claim 10, wherein the pushing axis is vertical regardless of how the surface of the cathodes is inclined.

12. The guiding rod of claim 10, wherein the pushing axis is normal to the surface of the cathodes.

13. The guiding rod of claim 10, further comprising at least one of bushings and bearings around the ram for providing rotatability of the ram around the pushing axis.

14. A method for compacting a ramming paste inside a gap between cathodes of an electrolytic cell, the method comprising:
providing, using a guiding rod, a static pressure in a longitudinal axis which is coincident with the guiding rod;
providing an oscillatory pressure at a vibration generator; and
transmitting, with a compaction tool, the static pressure and the oscillatory pressure to the ramming paste inside the gap.

15. The method of claim 14, wherein using a guiding rod comprises using a guiding rod having a weight, wherein providing a static pressure comprises applying the weight of the guiding rod.

16. The method of claim 14, wherein using a guiding rod comprises using a guiding rod comprising piston, wherein providing a static pressure comprises applying a force with the piston.

17. The method of claim 16, wherein using a guiding rod further comprises using a guiding rod having a weight, wherein providing a static pressure comprises applying the weight of the guiding rod.

18. The method of claim 14, wherein providing an oscillatory pressure comprises rotating eccentric weights for generating a vibration and further comprising manually adjusting a position of the eccentric weights to thereby vary the oscillatory pressure.

19. The method of claim 14, further comprising horizontally translating the guiding rod over the cathodes of the electrolytic cell for compacting a ramming paste inside another gap.

20. The method of claim 14, further comprising pulling up the guiding rod higher than walls of the electrolytic cell for enabling horizontal translation of the guiding rod over another electrolytic cell without lifting all mechanical components used in the method.
